(19) United States
(12) Patent Application Publication
(10) Pub. No.: US 2025/0264394 A1
(43) Pub. Date: Aug. 21, 2025

(54) APPARATUS AND METHOD FOR CONVECTION FLOW ASSISTED PERMEATION EVALUATION OF MATERIALS AGAINST CHEMICALS

(71) Applicant: Chairman, Defence Research & Development Organisation (DRDO), New Delhi (IN)

(72) Inventors: Prabhat Garg, Gwalior (IN); Sandeep Patel, Gwalior (IN); Vikas Baburao Thakare, Gwalior (IN); Arvind Kumar Gupta, Gwalior (IN)

(21) Appl. No.: 18/858,424

(22) PCT Filed: Apr. 20, 2023
(86) PCT No.: PCT/IN2023/050380

§ 371 Date: Oct. 21, 2024

(30) Foreign Application Priority Data
Apr. 21, 2022 (IN) 202211023572

(51) Int. Cl. G01N 15/08; G01M 3/04

(52) U.S. Cl. CPC G01N 15/082; G01M 3/04

(57) ABSTRACT

Present disclosure relates to a permeation test cell for permeation testing of materials against chemicals, and comprises an upper body provided with an upper cell cap having a first vent and a lower body provided with a lower cell cap having a second vent. A test sample is disposed in the permeation test cell. A liquid contaminant is spiked onto test sample. After contamination of the test sample, a gaseous stream is passed through the upper cell cap and the lower cell cap in a direction perpendicular to a surface of the test sample, for assisting permeation of the contaminant through the test sample. The lower cell cap is provided with a cavity to store a sorbent material for accumulation of the permeated contaminant in the sorbent material.

### CROSS-REFERENCE TO RELATED APPLICATIONS

The present application is a submission under 35 U.S.C. § 371 which claims priority to International Application No. PCT/IN2023/050380, filed Apr. 20, 2023, which claims priority to Indian Application No. 202211023572, filed Apr. 21, 2022, the disclosures of which are incorporated herein by reference in their entireties.

### FIELD OF INVENTION

The present invention herein generally relates to an apparatus and a method for permeation testing of materials and more specifically relates to an apparatus and a method for permeation testing of the materials used for protective ensembles against toxic chemicals especially chemical warfare agents or their simulants.

### BACKGROUND

Toxic chemicals especially chemical warfare agents (CWA) are being used in asymmetric war across the borders or even within the civil population. There is much concern regarding exposure of the CWA to personnel involved in handling these agents or incidents related to exposure of these hazardous chemicals in vapor or liquid form to personnel. Continuous efforts are going on for the advancement in protective ensembles required for individual for protection against the toxic chemicals especially CWA. The functional performance evaluation of these protective ensembles need to be carried out against the chemicals of interest in permeation configurations mimicking realistic scenarios.

A number of methodologies exist for measurement of permeation of toxic chemicals. One of the methodologies for measurement of permeation of toxic chemicals especially CWA or their stimulants is the U.S. Army Test Operating Procedure 08-2-501 (TOP) and 08-2-503 (TOP). After testing by TOP, the contaminants permeating through a protective material then have to be measured using other conventional techniques. There are various techniques of measurement of quantitative permeation density. The techniques include using chemical agent monitors (CAM) or by desorption of sorbent tube placed at the outlet in the lower body of permeation test cell followed by evaluation by a chromatographic or spectroscopic technique.

TOP specifies the apparatus and protocols for permeation measurements depending upon configuration of permeation and permeation mode. Configuration of permeation is based on the physical state of chemical in permeated condition. The configurations of permeation include either liquid contamination vapor detection (L/V) or vapor contamination vapor detection (V/V) or liquid contamination liquid detection (L/L) configurations. Permeation modes are based on the flow of air/gas and its direction affecting resultant permeation. The permeation modes include static diffusion mode, dual flow mode and convective flow mode, in line with realistic permeation scenario by effect of air flow. In static diffusion mode, there is no flow of dry air/inert gas and permeation drives due to concentration gradient between upper and lower bodies of permeation cell and gravity. Evaluation of permeation of chemical in protective materials in static diffusion mode is possible only with L/V and L/L configurations. In dual flow mode, a stream of dry air/inert gas or contamination in vapour form is passed over and parallel to the contaminated sample and permeation is affected due to this flow of dry air/inert gas over the contamination. Evaluation of permeation of chemical in protective materials in dual flow mode is possible with all three L/V, L/L and V/V permeation configurations. In convective flow mode, a stream of air/inert gas or contamination in vapour form is passed across the sample. Evaluation of permeation of chemical in protective materials in convective flow mode is possible with L/V and V/V permeation configurations only.

FIG. 1A illustrates a schematic diagram of sealed view of a permeation test cell (100), as described in the TOP 08-2-501, in accordance with prior art. FIG. 1B illustrates an unassembled view of the permeation cell (100) for L/V and V/V configuration in static-diffusion and dual-flow modes, as described in the TOP 08-2-501, in accordance with prior art. FIG. 2A illustrates an unassembled view of permeation test cell as described in the TOP 08-2-501, in accordance with prior art. FIG. 2B illustrates a sealed view of the permeation test cell (200) for L/V and V/V configuration in convective-flow mode as described in TOP 08-2-501, in accordance with prior art.

According to TOP 08-2-501, in static-diffusion and dual flow mode with L/V and V/V configurations, a stream of dry air/inert gas is also passed through lower body of permeation cell to sweep the permeated contamination to the sorbent tube consisting sorbent material. Permeation density is quantified using Chemical Agent Monitors (CAM) or by desorption sorbent material available in sorbent tubes/bubblers placed at the outlet in the lower body of test cell followed by quantification using chromatographic/spectroscopic technique. The stream of dry air/inert gas at ambient temperature may not be able to vaporise permeated contaminant completely especially in case of low volatile CWA, e.g., VX and Novichokes and thus the accuracy of the method is compromised. FIG. 3 illustrates test conditions in L/V configurations according to TOP 08-2-501A and FIG. 4 illustrates test conditions in V/V configurations according to TOP 08-2-501A.

TOP 08-2-501 further covers the methodology for permeation testing of protective materials in liquid contamination liquid detection (L/L) configuration using expulsion mode, inverted expulsion mode and mandrel mode, to evaluate the resistance of protective material against toxic chemical especially CWA or its simulant qualitatively under external pressure. The expulsion mode is important for the protective materials to be evaluated under external pressure in line with realistic scene where a contaminated surface is touched or contaminated object is grasped by the personnel wearing protective gears. As per TOP 08-2-501, there is a difference of contamination density between permeation testing in conventional L/V, V/V and L/L expulsion permeation modes. According to TOP 08-2-501, in L/V configuration and V/V configuration with all the static-diffusion mode and dual flow mode, contamination density is 10 g/m² which is administered in the form of 8 or 10 drops (each 1 μL) of single chemical agent on the sample area of 10 cm² while contamination density in qualitative expulsion mode is 2.5 g/m² in the form of single drop of 5 mg chemical agent on sample area of 20 cm². Evaluation of materials using expulsion mode is purely qualitative in nature and breakthrough time is measured in contrast to permeated density of chemical agent.

TOP 08-2-503 provides standard methods for testing the permeation of low volatility chemicals, such as persistent nerve agent e.g., VX through swatches of protective materials in L/L configuration. FIG. 5 illustrates an apparatus (500) of expulsion test, as described in TOP 08-2-503, in accordance with prior art. The apparatus (500) consists of a cylindrical stainless-steel weight (502) (453.6 gms) applied on a test sample (504) carrying a chemical agent drop/contaminant (506). According to TOP 08-2-503, a sorbent disc (508) is used underneath the test sample (504) to adsorb/absorb the permeated quantity of the contaminant (506), in the liquid form. The method is described for the quantitative expulsion mode where permeation is evaluated under stress to mimic the realistic scenario where wearer of protective ensemble touches the contaminated surface or holds a contaminated object. In expulsion test mode, 1 psi external pressure is applied to material contaminated with single chemical agent drop (5 mg of neat agent or 8 mg of thickened agent). Permeation density is calculated by extraction of contamination from sorbent disc placed underneath of test sample (504) swatch as per TOP 08-2-503 followed by evaluation using a chromatographic/spectroscopic technique. Use of sorbent disc in TOP 08-2-503, makes the method costlier.

Low volatility Chemical Warfare Agents (CWAs) are most hazardous due to their very low percutaneous median lethal dose (LD60) value and high penetration through the skin of wearer. Thus, accuracy in permeation evaluation of protective materials against low volatility CWAs such as VX and Novichokes in convective flow mode with L/V configuration is very important. TOP 08-2-503 does not describe apparatus and method for the quantitative permeation evaluation of protective materials in convective mode with L/V configuration for low volatility chemicals. Moreover, in both the TOP 08-2-501 and TOP 08-2-503, apparatus and methodologies are described where a larger size of sample swatch is used (exposed area 10 cm²) and accordingly a large amount of toxic contaminant, especially chemical warfare agent is required to maintain the prescribed contamination density (10 g/m²), which poses a higher threat of exposure.

Therefore, in view of the foregoing limitations, there is a need for an apparatus and a method to enable quantified testing of permeation of contaminants through a protective material mimicking an environmental condition where air is directly striking the contaminated surface and supplementing more permeation of the contaminant.

### Objects of the Invention

A general object of the present invention is to devise an apparatus and a method for permeation testing of protective materials in convective mode to enable quantification of the permeation density of the chemical contaminant.

Another objective of the invention is to offer an apparatus and a method for permeation testing instilling high confidence in protective capabilities of the material tested, with low testing costs, and minimum variation in the result of the test of the same sample.

Another objective of the invention is to offer an apparatus and a method for permeation testing to measure the resistance of the materials used in protective ensembles like body suits, gloves, shoes, mask, haversack, cadaver bag etc. against toxic chemicals especially chemical warfare agents or their simulants.

Yet another objective of the present invention is to offer an apparatus and a method for permeation testing that simulates conditions reflecting more realistic environmental scenarios encountered in real-life.

### SUMMARY OF THE INVENTION

The summary is provided to introduce aspects related to an apparatus and method for convective flow assisted permeation evaluation of materials against chemical contaminants, and the aspects are further described below in the detailed description. This summary is not intended to identify essential features of the claimed subject matter nor is it intended for use in determining or limiting the scope of the claimed subject matter.

In order to achieve the above-mentioned objects, according to an aspect of the present invention, a permeation test cell is disclosed. The permeation test cell may be designed to comprise of an upper body and a lower body. The upper body may be provided with an upper cell cap having a first vent and the lower body may be provided with a lower cell cap having a second vent allowing passage of a gaseous stream from the upper cell cap to the lower cell cap. A contaminant may be placed on an upper side of a test sample and the test sample may be disposed between the upper body and the lower body. A gaseous stream may be passed from the upper cell cap to the lower cell cap in a direction perpendicular to a surface of the test sample, for assisting permeation of the contaminant through the test sample.

In one aspect of the present invention, a cavity may be provided in the lower body to store a sorbent material for accumulation of the contaminant permeated through the test sample.

In one aspect, the permeation test cell may comprise a first O-ring and a second O-ring to prevent leakage of the contaminant from the edges of the test sample. The first O-ring may be positioned in contact with the upper body and the test sample, and a second O-ring may be positioned in contact with the lower body and the test sample.

In one aspect, the gaseous stream may be supplied through a first vent in the upper cell cap used as an inlet for release through a second vent in the lower cell cap.

In one aspect, a first perforated Polytetrafluoroethylene (PTFE) layer may be placed over the contaminant to contain the contaminant on the test sample.

In one aspect, a ring of colorimetric detector paper may be placed underneath the test sample and on periphery of the test sample to determine leakage of the contaminant from the edges of the test sample.

In one aspect, a second PTFE layer may be placed between the test sample and the sorbent material to blocks permeation of the contaminant through the test sample and determine leakage of the contaminant from edges of the test sample to the sorbent material.

In another aspect, a method for testing permeation of chemical contaminations through a material is described. The method may comprise providing an upper body including an upper cell cap for passing a gaseous stream to a lower cell cap present in the lower body. A contaminant may be applied on an upper side of a test sample, wherein the test sample is placed between the upper body and the lower body. The upper body of the test cell may be sealed with the lower body. A gaseous stream may be supplied in a direction perpendicular to a surface of the test sample, for assisting permeation of the contaminant through the test sample.

In one aspect, a cavity in the lower body may be filled with a sorbent material for accumulation of the contaminant permeated through the test sample.

In one aspect, the gaseous stream may be supplied through a first vent in the upper cell cap used as an inlet for release through a second vent in the lower cell cap.

These and other aspects of the embodiments herein will be better understood and appreciated when considered in conjunction with the following descriptions and accompanying drawings. It should be considered, however, following descriptions, while indicating preferred embodiments and details thereof are for illustration and not of limitation. Changes and modifications may be made within the scope of embodiments described here without departing from spirit thereof. The embodiments herein include all such modified embodiments.

### BRIEF DESCRIPTIONS OF DRAWINGS

The accompanying drawings are used to provide further understanding of the present invention. Such accompanying drawings illustrate the embodiments of the present invention which are used to describe the principles of the present invention. The embodiments are illustrated by way of example and not by way of limitation in the figures of the accompanying drawings in which like references indicate similar elements. It should be noted that references to “an” or “one” embodiment in this invention are not necessarily to the same embodiment, and they mean at least one. In the drawings:

FIG. 1(A) illustrates a schematic diagram of sealed view of a permeation test cell as described in the TOP 08-2-501, in accordance with prior art;

FIG. 1(B) illustrates an unassembled view of the permeation cell for L/V and V/V configuration in static-diffusion and dual-flow modes of sealed view, as described in the TOP 08-2-501, in accordance with prior art;

FIG. 2(A) illustrates an unassembled view of permeation test cell as described in the TOP 08-2-501, in accordance with prior art;

FIG. 2(B) illustrates a sealed view of the permeation test cell for L/V and V/V configuration in convective-flow mode as described in TOP 08-2-501, in accordance with prior art;

FIG. 3 illustrates test conditions in L/V configurations according to TOP 08-2-501A, in accordance with the prior art;

FIG. 4 illustrates test conditions in V/V configurations according to TOP 08-2-501A, in accordance with prior art;

FIG. 5 illustrates an apparatus of expulsion test as described in TOP 08-2-503, in accordance with prior art;

FIG. 6(A) illustrates a sealed view of a permeation test cell, in accordance with an embodiment of the present invention;

FIG. 6(B) illustrates an unassembled view of the schematic of the permeation test cell, in accordance with an embodiment of the present invention;

FIG. 7 illustrates test parameters of convective flow assisted quantitative permeation test method in L/V configuration, in accordance with an embodiment of the present invention;

FIG. 8 illustrates characteristics of Activated Carbon Sphere (ACS) based three layered composite and Activated Carbon Fabric (ACF) based three layered composite, tested against chemical of interest, in accordance with an embodiment of the present invention;

FIG. 9 illustrates the results of average permeation and standard deviation for a number of replicates of the test sample of ACS and ACF, in accordance with an embodiment of the present invention;

FIGS. 10(A), 10(B), and 10(C) illustrate schematic diagrams of modified permeation test cell to measure permeation in L/V configuration with convective flow mode, in accordance with embodiments of the present invention; and

FIG. 11 illustrates a method of convective flow assisted permeation testing of contaminant in L/V configuration, in accordance with an embodiment of the present invention.

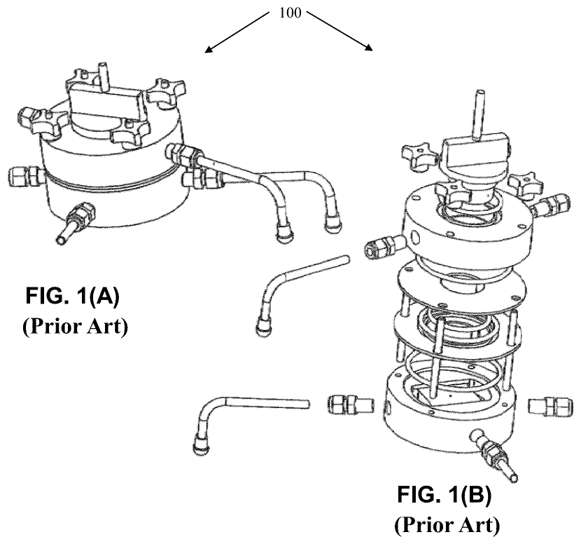

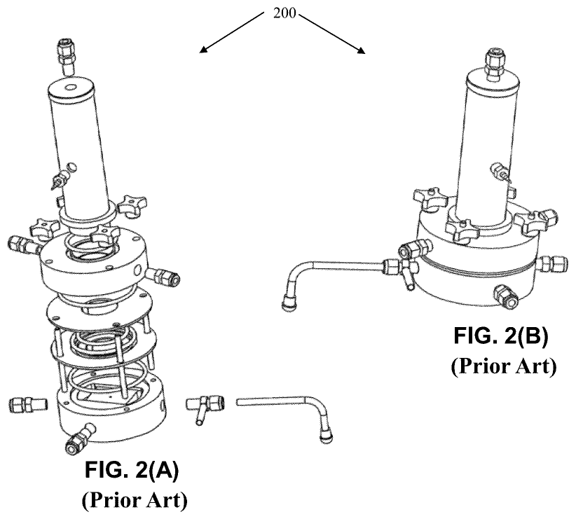

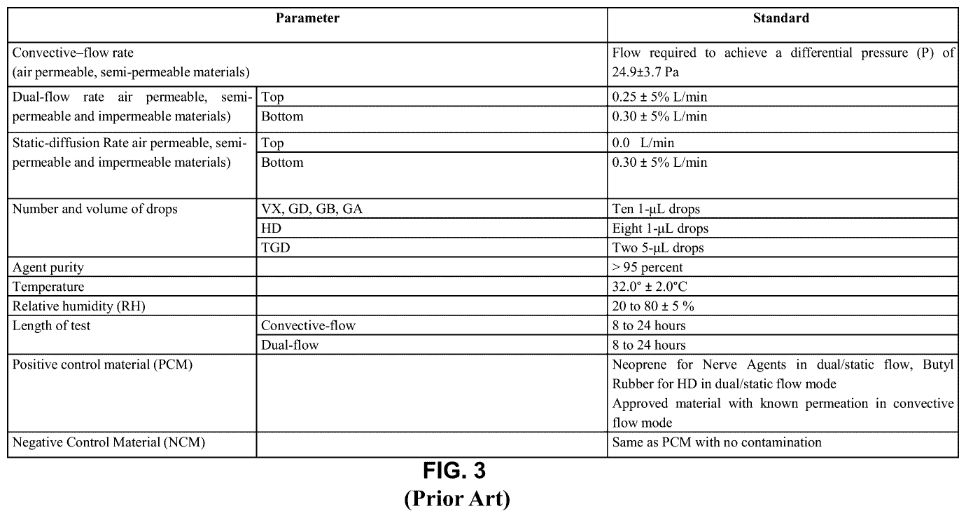

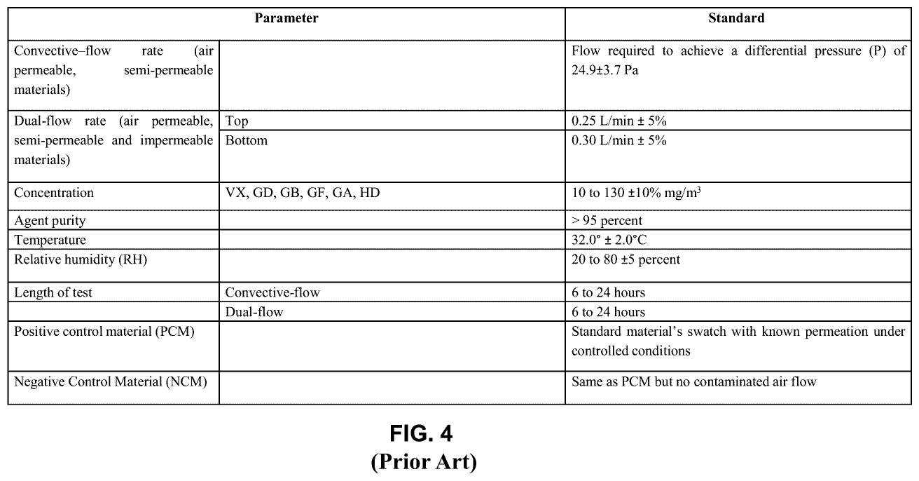

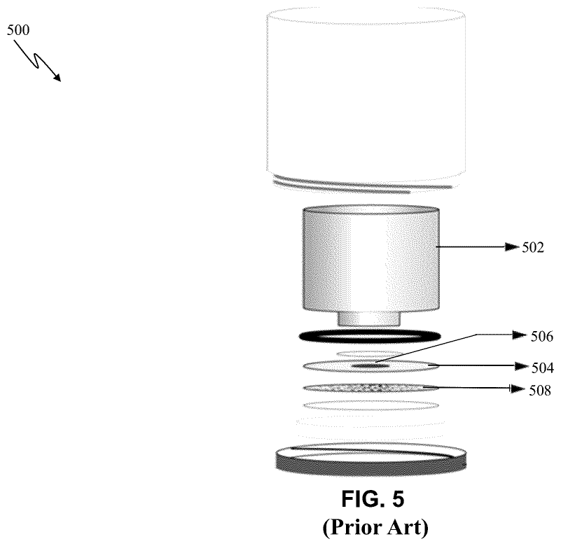

### DETAILED DESCRIPTION OF THE INVENTION

The detailed description set forth below in connection with the appended drawings is intended as a description of various embodiments of the present invention and is not intended to represent the only embodiments in which the present invention may be practiced. The various features of the present invention are explained fully with reference to the non-limiting embodiments. Details of commercial off the shelf and well-known components along with their processes to use have not been included in the embodiments mentioned here to simplify the explanations. The examples given herein should not be construed as limiting the scope of embodiments given herein and are intended to facilitate the understanding of ways in which the embodiments may be practiced by those of skilled in the art.

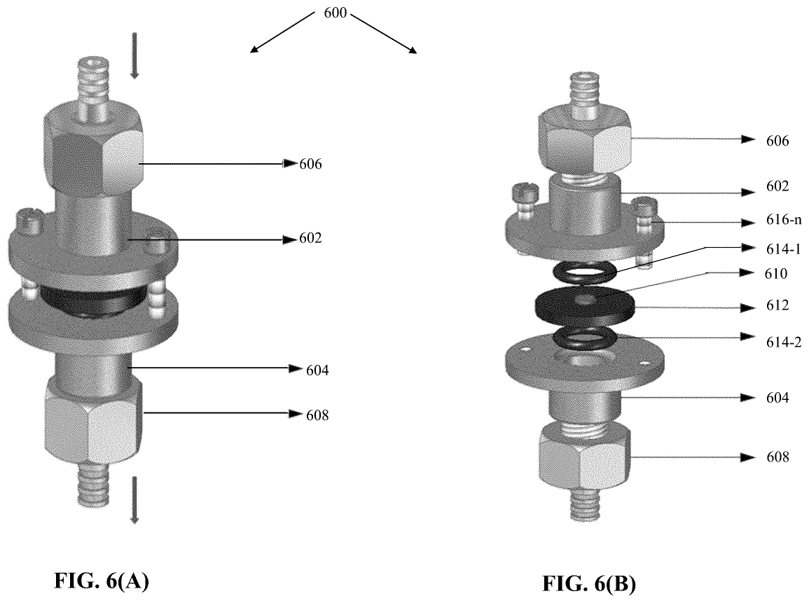

The present invention relates to an apparatus and a method for convective flow assisted permeation evaluation of materials against chemical contaminants. FIG. 6(A) illustrates a sealed view of a permeation test cell (600), in accordance with an embodiment of the present invention. As illustrated in FIG. 6(A), the permeation test cell (600) may comprise an upper body (602) and a lower body (604). The upper body (602) may comprise an upper cell cap (606) having a first vent. The lower body (604) may comprise a lower cell cap (608) having a second vent. The upper cell cap (606) and the lower cell cap (608) may be used for passing a gascous stream from the upper body (602) across the lower body (604) in the permeation test cell (600). In one implementation, the permeation test cell (600) may be made of stainless-steel grade 316, reducing the chances of corrosion due to use of highly corrosive toxic chemicals especially chemical warfare agents or their simulants.

FIG. 6(B) illustrates an unassembled view of the schematic of the permeation test cell (600), in accordance with an embodiment of the present invention. The test sample (612) may be placed between the lower body (604) and the upper body (602). The lower body (604) may be provided with a cavity to fill a sorbent material for accumulation of contaminant (610) permeated through the test sample (612). To ensure that the sorbent material touches the surface of the test sample (612) swatch, the lower cell cap (608) may be filled with glass wool and tightened to the lower body (604). A contaminant (610) may be placed on an upper side of a test sample (612). The permeation test cell (600) may comprise O-rings (614-n) positioned between the upper body (602) and lower body (604). The O-rings (614-n) may be used for prevention of leakage of the contaminant (610) from the edges of the test sample (612). For example, a first O-ring (614-1) may be positioned in contact with the upper body (602) and the test sample (612). A second O-ring (614-2) may be positioned in contact with the lower body (604) and the test sample (612). The glass wool may also help in retaining the sorbent material in the lower body (604). After placement of the test sample (612) with the contaminant (610) between the upper body (602) and the lower body (604), the upper body (602) and the lower body (604) of the permeation test cell (600) may be sealed with the use of screws (616-n).

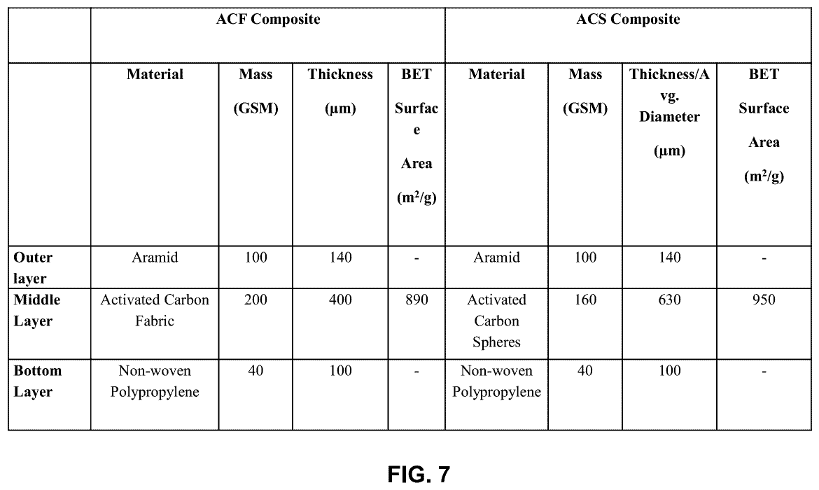

In one implementation, the permeation test cell (600) may be suitable for a protective material sample swatch of minimum 1.5 cm diameter with exposed surface areas of 1.0 cm². Quantification of permeation of the contaminant (610) may be performed in liquid contamination vapour detection (L/V) configuration for convective flow mode with limited quantity of test sample (612) and limited quantity of contaminant (610). The upper surface of protective material test sample (612) may be challenged with a single drop of 1.0 mg/0.8 mg contaminant (610) to maintain the desired contamination density of 10 g/m². After placement of the contaminant (610), the upper cell cap (606) of permeation test cell (600) may be closed. Gaseous stream may be passed through the upper cell cap (606) across the test sample (612) for convective flow assisted permeation of the contaminant (610) through the test sample (612). The contaminant (610) permeated through the test sample (612) may be adsorbed in the sorbent material underneath the test sample (612). The permeation test cell (600) may be placed in an incubator for temperature control to simulate desired environmental controls. Permeation density of the material may then be quantified for the scenario when air is flowing across/through the test sample (612) affecting permeation of the contaminant (610). Quantitative determination of permeation is measured by desorption of contaminant from sorbent material using a solvent and analyses using chromatographic technique. FIG. 7 illustrates test parameters of convective flow assisted quantitative permeation test method in L/V configuration, in accordance with an embodiment of the present invention. The contamination density may be varied as per the requirement of permeation test conditions.

The permeation test cell (600) is suitable for permeation evaluation of material against low volatile agent, e.g., VX and Novichokes as the contamination path length is reduced to maximum possible by filling the sorbent material in the lower body (604), thereby avoiding need for a sorbent tube. Thus, there are no chances of low volatile contaminant remaining on the walls of lower body (604) causing misleading permeation results. The method employed in the permeation testing of the material via the permeation test cell (600) increases the confidence of protective capabilities of materials and reduces operational testing costs by using limited test sample (612), limited challenge contaminant (610), and use of sorbent material in place of sorbent disc or sorbent tube.

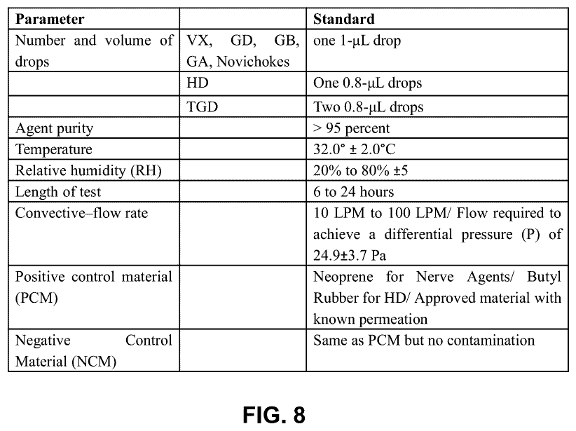

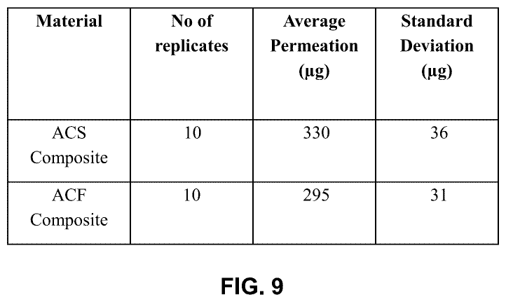

Some of the test methods performed for measuring the permeation of contaminants through materials are described below in non-limiting examples. FIG. 8 illustrates testing of two materials, an Activated Carbon Sphere (ACS) based three layered composite and an Activated Carbon Fabric (ACF) based three layered composite, against one compound of interest, VX, a CWA. The permeation test was carried for six hours. More than 10 replicates were tested for each composite, as well as minimum 10 control samples were tested. The test method used was based on the developed permeation test in convection mode in L/V configuration as described above. The test parameters mentioned in FIG. 8 were utilized. FIG. 9 illustrates the results of average permeation and standard deviation for each replicate of the test sample tested. It was observed that the Standard Deviation (SD) of the permeated amount of contamination is large especially with ACS composite which may be due to non-uniformity in the replicate test samples. It is apparent that the present invention provides improvements to the conventional test methods to enable quantification of permeated amount and temperature control.

There exists a possibility that the contaminant (610), instead of passing through the test sample (612), travels through the edges of the test sample (612) and reaches the lower body (604) despite the O-rings (614-n) tightening on the edges. This leakage of the contaminant (610) may defeat the test method. To rule out this situation, integrity of the permeation test cell (600) may be checked to ensure that there is no leakage of contaminant (610) through edges of the test sample (612) in the sorbent material.

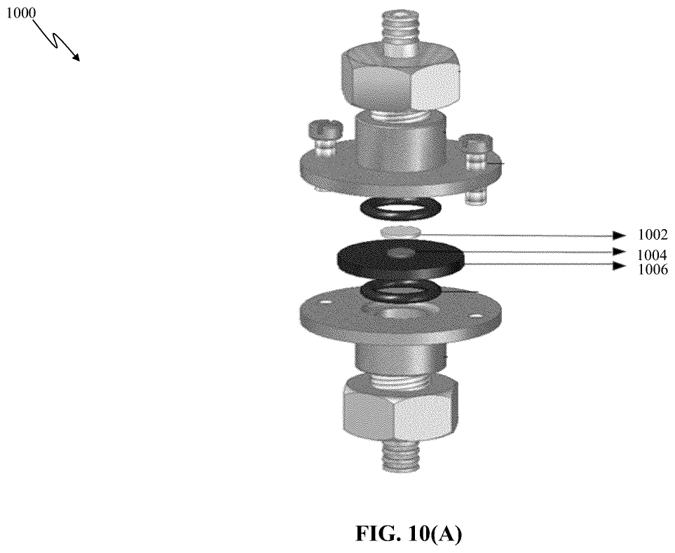

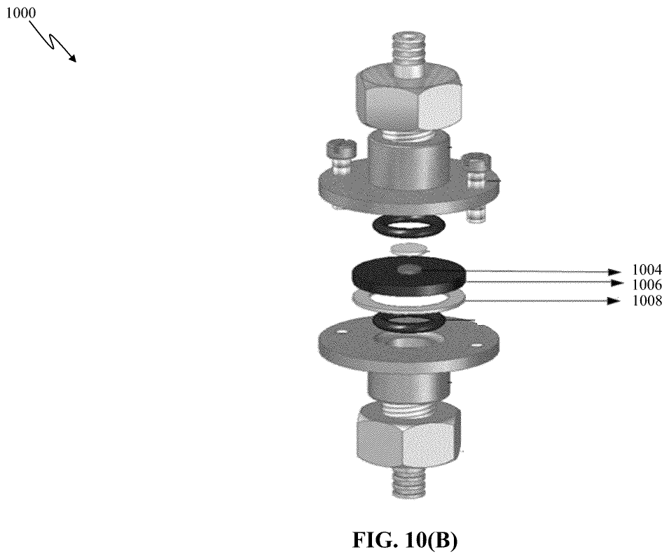

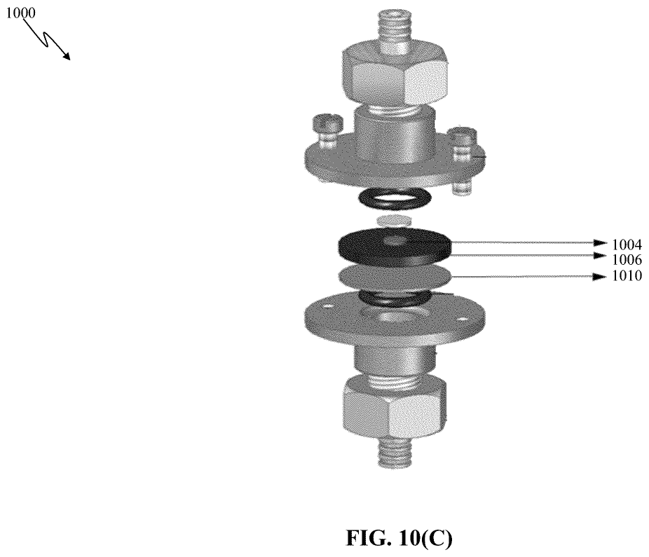

FIGS. 10(A), 10(B), and 10(C) illustrate schematic diagrams of permeation test cell (1000) to measure permeation in L/V configuration with convective flow, in accordance with embodiments of the present invention. As illustrated in FIG. 10(A), a first perforated Polytetrafluoroethylene (PTFE) layer (1002) may be placed over a contaminant (1004). The first PTFE layer (1002) contains the contaminant (1004) on a test sample (1006) and may also uniformly spread the contaminant (1004) on the test sample (1006).

As illustrated in FIG. 10(B), a ring of colorimetric detector paper (1008) may be placed underneath the test sample (1006) on the periphery of the test sample (1006). The colorimetric detector paper (1008) may assist in determining leakage of the contaminant (1004) from the edges of the test sample (1006). If contamination is passed through edges instead of passing through swatch sample, the colorimetric detector paper (1008) changes its color.

Further, to establish integrity of the permeation test cell (1000), that for a given contaminant and protective material combination, contaminant permeates through the test sample (1006) and not through the edges of the test sample (1006), characterization samples may be included before every batch of test sample. The purpose of these characterization samples may be used to demonstrate that the contaminant (1004) does not wick through the edges of the test sample (1006). As illustrated in FIG. 10(C), the permeation test cell (1000) may comprise a second PTFE layer (1010). The second PTFE layer (1010) may be placed between the test sample (1006) and the sorbent material. The second PTFE layer (1010) may block permeation of the contaminant (1004) through the test sample (1006) and may determine leakage of the contaminant (1004) from the edges of the test sample (1006) to the sorbent material. If any contamination is measured in the sorbent material, test is defeated for the combination of apparatus, material and contaminant.

Various quality controls were incorporated into the testing protocols of permeation testing including purity analyses of contamination, efficiency of sorbent material, positive control samples, negative control samples, verification of contamination quantity, testing leakage through edges of test sample and analytical control. The quality controls are further described below in non-limiting examples.

The swatches were cut with sharp edged steel die and press. For the protective body suit, an equal number of swatches are taken from front, back, arms and legs. Gas tight syringe may be used for spiking the liquid contaminant onto the sample swatch. A calibrated balance may be used for the verification of the weight of spiked contaminant. Solvents used in the testing were of chromatography grade.

As a part of quality control of the system, the efficiency of Fluka make ORBO™ 609 Amberlite® XAD®-2 sorbent material was determined. For determining efficiency of sorbent material with respect to particular chemical, solution of 5 μg, 10 μg, 100 μg, 500 μg and 5 mg of the chemical in solvent was spiked onto the 500 mg sorbent material separately. A larger area of the sorbent material got wet. The total mass adsorbed fit within the calibration curve of analytical instrument and was within the range of concentrations in which the sorbent material is expected to perform. Once the solvent is evaporated, the sorbent material was taken and extracted with 20 mL of ethyl acetate for approx. 30 minutes and quantitative determination is carried out by fitting the data into calibration curve based on the standard solutions of the chemical. Other solvents may be used, as appropriate for the particular contaminants and/or analytical technique. The extractant was analyzed with gas chromatography-mass spectrometer (GC-MS) (not shown) having quantification limit of approximately 1 μg/mL. Improved limit of detection may be achieved using other analytical tools.

Another quality control parameter is purity of the contaminant. The use of low purity contaminant may lead to incorrect results. In another embodiment of the present invention, the purity of the contaminant may be checked using analytical technique such as Nuclear Magnetic Resonance (NMR) Spectroscope (not shown).

In another implementation of the present invention, the repeatability of gas tight syringe may be checked using gravimetric method. The target amount taken into gas tight syringe may be weighed accurately by taking into a vial using calibrated electronic balance (not shown) and variance may be recorded.

In another implementation of the present invention, the temperature of the incubator (not shown) may be set to approximate at 32° C. or any other desired value and verified using a calibrated temperature recorder (not shown). The permeation test cell (1000) may be allowed to equilibrate for at least 24 hours prior to each test. Temperature may be recorded every minute to note the variance. Other temperature may be used as required by test conditions.

Positive control sample may be required before or simultaneously with testing the actual sample. The purpose of positive control sample is to ensure the performance of testing methodology and apparatus used. Butyl rubber/material with known permeation density in case of HD and neoprene/material with known permeation density for nerve agents (GB, GD, GA, VX, Novichokes) in the controlled conditions may be taken as positive control sample.

Negative control sample may also be required to run before or simultaneously with the actual sample. Negative control sample could be the same as positive control sample but without any contamination. The purpose of negative control is to demonstrate the proper working of test apparatus and methodology and that there is no cross contamination that could occur from tools or other test cells. Contaminants are not measured above the quantification limit for any of the negative control samples.

The analytical methods used herein include a calibration curve prepared by quality check samples to increase the confidence in the data. The limit of quantitation is measured by the standard sample of lowest concentration in the calibration curve. The calibration curve should be linear with value of R² ranging from 0.995 to 0.999.

In another implementation of the present invention, to assess the upper limit for bias and account for sample loss due to interaction of contaminant with the second PTFE layer (1010). The second PTFE layer (1010) may be spiked with the contamination and placed over the lower body (604). Contaminants may be covered with the first PTFE layer (1002). The sample follows the same test process but without sorbent material. After certain duration, both the PTFE layers—may be extracted independently and sample loss may be checked by comparing the extracted quantity of contaminant with the original contaminant amount. The sum of both the PTFE layers—extraction results is expected to be equal to the original contamination level. The difference is attributed to potential loss during the entire process.

The present invention may be used for permeation through any of air permeable and semi permeable protective materials. The method and apparatus evaluates performance under conditions that reflect more realistic use in different environmental scenarios, such as mimicking forces associated with a contaminated surface being hit directly by air. The present invention provides a quantitative test method to indicate that the lack of measured permeation mass through negative control sample in the protective material may provide suitable protection for approximately 6 hours.

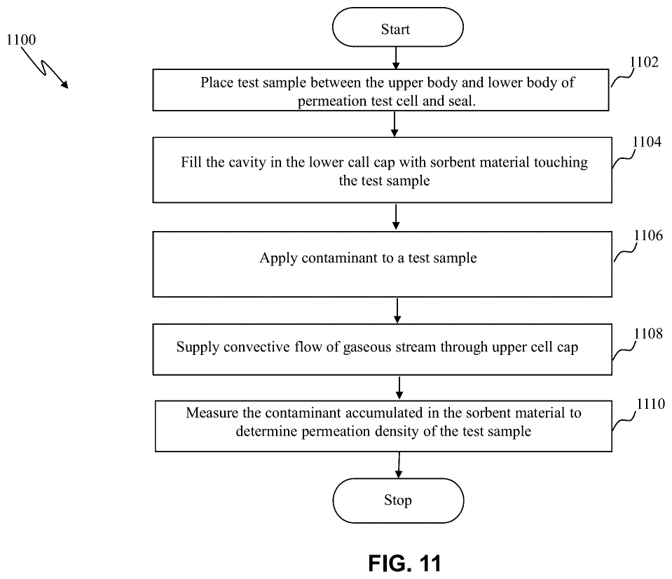

FIG. 11 describes a method (1100) of convective flow assisted permeation testing of contaminant in L/V configuration, in accordance with an embodiment of the present invention. It should be noted that in some alternative implementations, the steps may occur out of the order or maybe executed substantially concurrently or may be modified to execute the method combining other components of the invention, depending upon the embodiments of the present invention.

At block 1102, to initiate permeation testing of a test sample (612) in a permeation test cell (600), the test sample (612) may be placed in the permeation test cell (600) between an upper body (602) and a lower body (604) of the permeation test cell (600). At block 1104, a cavity in a lower cell cap (608) provided in the lower body (604) may be filled with a sorbent material, ensuring that the sorbent material touches the test sample (612) from beneath. At block 1106, a contaminant (610) may be applied onto the test sample (612). The contaminant (610) may be present in liquid form. The permeation test cell (600) may then be sealed. At block 1108, a gaseous stream may be supplied through the upper cell cap (606) across the test sample (612). At block 1110, the contaminant (610) permeating through the test sample (612) may be accumulated in the sorbent material and measured using chromatographic technique for quantitative determination of the permeation density of the test sample (612).

The detailed description set forth above in connection with the appended drawings is intended as a description of various embodiments of the present disclosure and is not intended to represent the only embodiments in which the present disclosure may be practiced. Each embodiment described in this disclosure is provided merely as an example or illustration of the present disclosure, and should not necessarily be construed as preferred or advantageous over other embodiments.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A permeation test cell for testing permeation of chemical contaminants through a material, the permeation test cell comprising:
an upper body including an upper cell cap and a lower body including a lower cell cap, wherein the upper body and the lower body are sealed together after placing a contaminant on an upper side of a test sample, the test sample being placed between the upper body and the lower body,
wherein the upper cell cap allows passage of a gaseous stream to the lower cell cap, in a direction perpendicular to a surface of the test sample, for assisting permeation of the contaminant through the test sample.

2. The permeation test cell as claimed in claim 1, comprising a cavity in the lower body to store a sorbent material for accumulation of the contaminant permeated through the test sample.

3. The permeation test cell as claimed in claim 1, comprising a first O-ring and a second O-ring to prevent leakage of the contaminant from edges of the test sample, wherein the first O-ring is positioned in contact with the upper body and the test sample, and the second O-ring is positioned in contact with the lower body and the test sample.

4. The permeation test cell as claimed in claim 1, wherein the gaseous stream is supplied through a first vent in the upper cell cap used as an inlet for release through a second vent in the lower cell cap.

5. The permeation test cell as claimed in claim 1, comprising a first perforated Polytetrafluoroethylene (PTFE) layer placed over the contaminant to contain the contaminant on the test sample.

6. The permeation test cell as claimed in claim 1, comprising a ring of colorimetric detector paper placed underneath and on periphery of the test sample, wherein the colorimetric detector paper determines leakage of the contaminant from edges of the test sample.

7. The permeation test cell as claimed in claim 2, comprising a second PTFE layer placed between the test sample and the sorbent material, wherein the second PTFE layer blocks permeation of the contaminant through the test sample and determines leakage of the contaminant from edges of the test sample.

8. A method for testing permeation of chemical contaminations through a material, the method comprising:
providing an upper body including an upper cell cap for passing a gaseous stream to a lower cell cap presenting the lower body;
wherein the test sample is placed between the upper body and the lower body, applying a contaminant on an upper side of a test sample;
sealing the upper body of the test cell with the lower body; and
supplying a gaseous stream in a direction perpendicular to a surface of the test sample, for assisting permeation of the contaminant through the test sample.

9. The method as claimed in claim 8, comprising filling a cavity in the lower body with a sorbent material for accumulation of the contaminant permeated through the test sample.

10. The method as claimed in claim 8, comprising positioning a first O-rings and a second O-ring to prevent leakage of the contaminant from edges of the test sample, wherein the first O-ring is positioned in contact with the upper body and the test sample, and the second O-ring is positioned in contact with the lower body and the test sample.

11. The method as claimed in claim 8, comprising supplying the gaseous stream through a first vent in the upper cell cap used as an inlet for release through a second vent in the lower cell cap.

12. The method as claimed in claim 8, comprising placing a first perforated Polytetrafluoroethylene (PTFE) layer over the contaminant to contain the contaminant on the test sample.

13. The method as claimed in claim 8, comprising placing a ring of colorimetric detector paper underneath and on periphery of the test sample, wherein the colorimetric detector paper determines leakage of the contaminant from the edges of the test sample.

14. The method as claimed in claim 9, comprising placing a second PTFE layer placed between the test sample and the sorbent material, wherein the second PTFE layer blocks permeation of the contaminant through the test sample and determines leakage of the contaminant from edges of the test sample.
